(19) United States
(12) Patent Application Publication
(10) Pub. No.: US 2017/0108361 A1
(43) Pub. Date: Apr. 20, 2017

(54) Target Flowmeter

(71) Applicant: CDI Meters, Inc., Woburn, MA (US)

(72) Inventor: Roger E. Dennison, Lexington, MA (US)

(21) Appl. No.: 15/296,671

(22) Filed: Oct. 18, 2016

Related U.S. Application Data
(60) Provisional application No. 62/243,075, filed on Oct. 18, 2015.

(51) Int. Cl. G01F 1/07; G01F 1/28; G01F 1/08

(52) U.S. Cl. CPC G01F 1/07; G01F 1/08; G01F 1/28

(57) ABSTRACT

A flowmeter of the target type, having a flow-sensing probe constructed to be inserted into a pipe through a small hole. The required small size is achieved in part by allowing the probe to deflect and thus shift in orientation relative to the flow as the force on the probe changes, the resulting distortion of the signal being compensated for in firmware. The target is made contiguous with its support, maximizing the area presented to the flow relative to the size of the hole through which the probe is inserted. The flowmeter may be configured to be mounted to the outside of a pipe and include means for sealing to the outside of the pipe. It may also include pressure- and temperature-sensing elements and means to calculate mass flow of a gas.

### CROSS-REFERENCE TO RELATED APPLICATION

This application claims priority of Provisional Patent Application Ser. No. 62/243,075 filed on Oct. 18, 2015, the disclosure of which is incorporated herein by reference.

### FIELD

This invention relates to a target flowmeter designed for easy installation in a compressed-air pipe.

### BACKGROUND

Compressed-air flows are commonly monitored with thermal flowmeters. However, these flowmeters are not suitable for applications in which the air contains suspended water droplets. Other types of flowmeter are available which are relatively insensitive to water droplets, but none of these are adapted for easy installation into an existing compressed-air line. Thermal flowmeters are also not suitable for measuring flows which may occur in either direction; such flows occur in looped compressed-air distribution systems.

Target flowmeters, which operate by sensing the force of moving fluid against an object placed in the air stream, are one type of flowmeter that is relatively insensitive to water droplets. Known designs are too bulky for insertion into a pipe through a small hole.

### SUMMARY

The subject flowmeter adapts a technology that is suitable for measuring flow of compressed air containing water droplets to easy installation in a compressed-air piping system. A single part functions as a target acted on by the moving fluid, the support for the target, the spring against which the force of the fluid acts, and, through a thin-film strain gauge formed on its surface, the sensor for the force of the fluid. This flow-sensing element, or vane, is mounted between fixed elements that prevent excessive movement in either direction and provide partial protection from damage during insertion into a pipe and from impact of particles and water droplets in the air stream. The assembly is formed into a narrow probe that inserts into a pipe through a small hole and is mounted in a split ring that seals against the outside of the pipe, allowing quick and easy installation. The probe may include a temperature sensor exposed to the temperature of the moving fluid, and it conducts the pressure of the fluid to a pressure sensor mounted in a pressurized enclosure outside of the pipe. A microprocessor, using a lookup table generated during calibration, calculates mass flow on the basis of the sensed force, temperature and pressure.

A version of the subject flowmeter is suitable for measuring flows occurring in either direction.

Two methods of mounting the flow-sensing vane are proposed. In one, suitable for bi-directional flow applications and for use in smaller pipes, the distal end of the vane is equally exposed on both sides and its proximal end extends into the pressurized enclosure outside of the pipe. In the other, for use in mono-directional flow, larger pipes and situations in which fast-moving droplets or particles may be present, the distal end of the vane is backed by a stop to prevent it from flexing too far in the downstream direction and the vane is mounted within the probe body and may be fully within the pipe.

This disclosure features in one aspect a flowmeter of the target type, including a probe that is arranged to be installed into a pipe through a small hole, where the pipe is arranged to carry a flow, the probe comprising a flow-sensing element that has a resting angular orientation relative to the flow. The probe is constructed and arranged to allow the flow-sensing element to change its angular orientation relative to the flow as the flow changes. The flowmeter may undergo a calibration process, and an effect of the change in orientation can be corrected for in the calibration process. The flowmeter may be a mass flowmeter. The probe may further comprise a protective support for the flow-sensing element configured to prevent the flow-sensing element from bending excessively due to applied flow, and further reducing the likelihood of damage to the flow-sensing element as the probe is inserted into a pipe.

In another aspect a flowmeter of the target type is configured to clamp to a pipe and seal to the pipe; the flowmeter comprises a flow-sensing probe projecting into the pipe.

In another aspect a flowmeter of the target type includes a probe that is arranged to be installed into a pipe through a small hole, where the pipe is arranged to carry a flow. The probe comprises a flow-sensing element and a support for the flow-sensing element, wherein the flow-sensing element has substantially the same width as the support, thereby maximizing the projected area in the flow stream with a given size of hole for insertion of the probe into the pipe.

### BRIEF DESCRIPTION OF THE DRAWINGS

Other objects, features and examples will occur to those skilled in the art from the following description and the accompanying drawings, in which:

FIG. 1 is an overall view of one example of a flowmeter mounted on a section of pipe, with the supporting ring and the pipe shown in section for clarity.

FIG. 2 is a top view of the flow-sensing vane.

FIG. 3 is a side view of a mono-directional probe, showing the probe body in section, the flow-sensing vane, the temperature sensor and the protective cover.

FIG. 4 is a sectional view taken along line 4-4 of FIG. 1, showing the pressurized enclosure, formed between the ring and a cover piece, and showing the mounting of the vane for bi-directional service, and a protective element for use in such service.

FIG. 5 shows the preparation of the temperature, pressure and force signals for the flow calculation.

FIG. 6 shows the flow calculation.

FIG. 7 shows the flow calculation for an alternative embodiment for saturated steam.

FIG. 8 is a side view of the flow-sensing vane, relating to the discussion of impacts at various points

### DETAILED DESCRIPTION

This disclosure pertains to a flowmeter of the target type adapted for easy installation in a compressed-air system. It is particularly intended for use with the moisture-laden air at the discharge of a compressor and prior to the drier and for bi-directional flows that occur in looped compressed-air distribution systems. It senses flow by means of a movable vane which flexes in response to the drag force created by the moving fluid. This vane is mounted in a slender probe that inserts into the pipe through a small drilled hole. The vane must be sensitive to small forces caused by slowly-moving air and at the same time be able to withstand the impact of rapidly-moving water droplets and solid particles. Consequently, the probe includes features to limit the motion of the vane and a protective cover to prevent impact of particles or droplets on the portion of the vane where they would be most likely to cause damage.

The flexing of the vane is sensed by a thin-film strain gauge deposited on the surface of the vane over an insulating layer. Use of this type of strain gauge, rather than a strain gauge applied with adhesive or cement, avoids potential drift caused by degradation of the attachment layer. A non-limiting example of a vane with a deposited strain gauge that can be used is the S100—Thin Film Load Cell available from SMD Sensors of Wallingford, Conn., USA.

An RTD to sense the temperature of the fluid may be mounted within the probe. A pressurized enclosure, mounted outside of the pipe and communicating through the probe with the inside of the pipe, contains an absolute-pressure sensor and circuitry to convert the signals from the temperature sensor and the strain gauge into digital form.

The probe is mounted on a split ring which seals to the pipe by means of a gasket. A cutout in the top of the ring, together with a cover piece form the pressurized chamber. Mounted to the ring is an electronic enclosure containing a microprocessor that calculates mass flow and a digital display. The meter is preferably mounted on the side or top of a horizontal pipe. The pipe should be horizontal to minimize gravitational effects on the vane of accumulating water or dirt. Placing it on the top or side of the pipe will also reduce the accumulation of debris that might interfere with the movement of the vane.

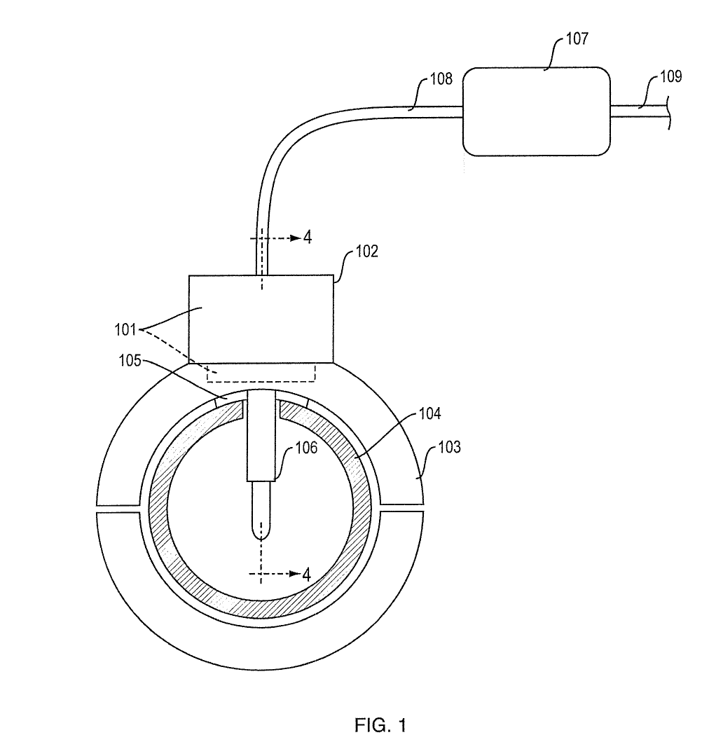

FIG. 1 is a view of the flowmeter mounted on a pipe with the pipe wall shown in section for clarity. The pressurized enclosure 101 is formed between cover piece 102 and a cutout in the upper part of split ring 103. The split ring clamps to the pipe 104 and seals to it by means of gasket 105. The two bolts holding the halves of the split ring together are not shown. The gasket is preferably made of synthetic rubber. The gasket is also shown in section for clarity. Probe 106 is shown projecting into the pipe.

A digital signal is transmitted from the pressurized enclosure to the display enclosure 107 by a short cable 108. The display enclosure contains a microprocessor which receives digital information from the pressurized enclosure. Using that information and a lookup table generated during the meter's calibration, the microprocessor determines the mass flow in the pipe. Cable 109 brings power to the meter and transmits information to outside instrumentation.

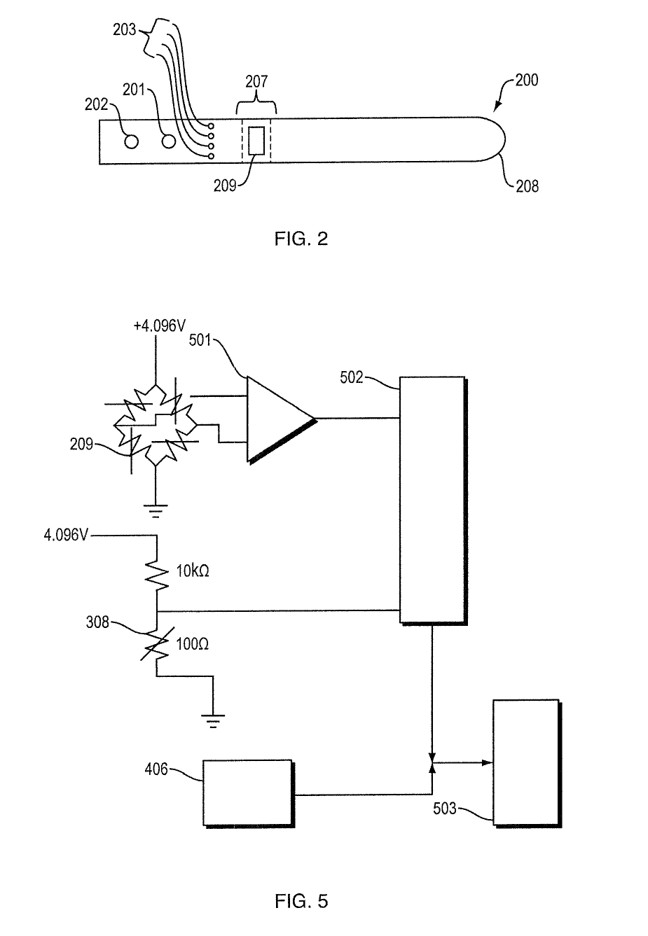

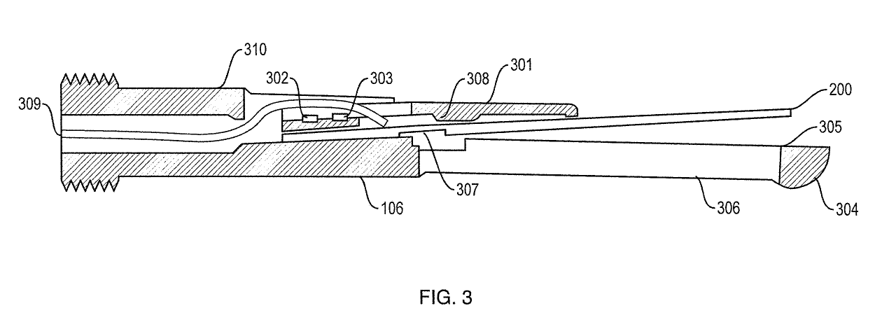

FIG. 2 is a top view of the flow-sensing vane 200 of probe 106. Mounting holes 201 and 202 facilitate securing the vane to its support. See FIG. 3 for details of one non-limiting example of the mounting of the vane. Region 207 of the vane is made to be flexible to allow distal end 208 to move in the direction normal to the plane of the view, while the remainder of the vane is sufficiently stiff that bending will occur preferentially in region 207. The relative flexibility may be produced by cutting away material on the underside of the vane in region 207, by drilling holes in region 207, by cutting away material at the sides of the part in region 207, or by some combination of these methods. It may also be accomplished by stiffening the beam outside of region 207 by forming lengthwise ridges, offsets or flanges, or by adding material.

A four-element strain gauge 209 is deposited over an insulating coating on the upper surface of the vane. The use of a strain gauge that is created in place, rather than one that is applied to the surface, avoids the use of adhesives or cements that could degrade in the hostile environment of hot, wet compressed air, and it provides further advantages in insensitivity to temperature and creep. The strain gauge senses longitudinal strain in region 207. It is connected to the circuitry in enclosure 101 by four wires 203. These wires are typically insulated. The vane is coated in the region of the strain gauge and the associated connections to protect against damage by moisture.

FIG. 3 is side view of one form of probe 106 showing the body of the probe 310 and protective cover 301 in section. In this configuration the body of the probe threads into ring 103 and provides support and partial protection for vane 200. Vane 200 is clamped in place between the protective cover and the body of the probe by screws 302 and 303. The probe body is configured to reduce the likelihood of damage to the vane during installation in the pipe, and to prevent the vane from flexing beyond its safe range of movement. The preferred direction of air movement is downward in FIG. 3. The distal portion of the probe body, 304, extends beyond the vane both to provide partial protection of the vane during installation in a pipe, and to provide backing to prevent the vane from flexing too far in the downstream direction in the event of high flow rates or impact by particles or water droplets. The top surface 305 of the distal portion of the probe body defines the angle the vane would assume at the limit of its deflection, this to limit the deflection to the greatest extent possible in the event of impact without unnecessarily reducing the range of motion of the vane. A cutout 306 in the probe body downstream of the vane eliminates a stagnant area behind the vane where particles could accumulate, and a notch 307 near the point of flexure eliminates small gaps where particles could settle and interfere with the movement of the vane.

In the mono-directional configuration, the vane is mounted angled toward the approaching flow, rather than perpendicular to it, to maximize the range over which the vane can flex and minimize the change of its angle to the flow as it flexes. The angle must be sufficient to allow for the range of movement of the vane, but not so great that the vane will interfere with inserting the probe into a pipe.

Protective cover 301 prevents impact of particles or water droplets on the vane in the area close to the region of flexure 207. Such impacts could be particularly damaging because, at the instant of impact, they would tend to cause rotation about the center of mass of the moving portion of the probe, counter-clockwise as seen in the diagram, causing stress at the point of flexure.

RTD 308 is glued to the underside of the protective cover 301. Two leads from the RTD and four leads from the strain gauge on the vane exit the probe through hole 309 in its proximal end. All of the connections of the leads to the RTD and the strain gauge are coated to prevent moisture from compromising the electrical signals.

Thread 310 provides for mounting the probe in a threaded hole in ring 103.

The probe body and the cover may be made of aluminum or stainless steel.

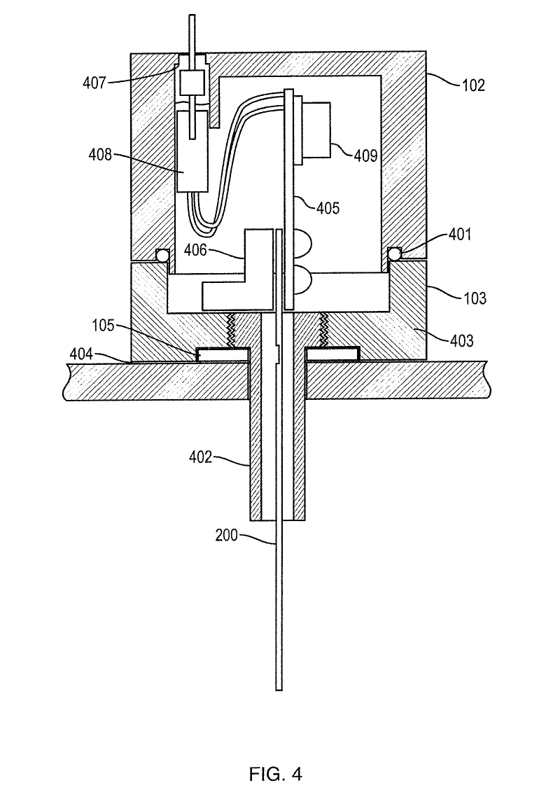

FIG. 4 is a sectional view through pressurized enclosure 101. Enclosure 101 is made up of cover portion 102 and ring 103, held together by screws (not shown) and sealed with an o-ring 401. The configuration shown is that for bi-directional flow, in which vane 200 is exposed to the flow equally on both sides and is partially protected by protective element 402. Element 402 threads into ring 103 in the same manner as probe 106; in either case the joint is sealed and made permanent by a suitable sealant. Ring 103 includes ridges 403, 404, that protect gasket 105 from being excessively compressed when the bolts are tightened securing the ring.

Vane 200 and circuit board 405 are affixed to support 406 which is in turn affixed to ring 103. If the vane were mounted within the probe, as in FIG. 3, the circuit board would be affixed directly to the support. Wires, not shown, connect the strain gauge on the vane to the circuit board. In this configuration, the RTD is a component on the circuit board rather than being mounted on the probe, thus simplifying wiring at a small cost in accuracy of temperature measurement. The circuit board also contains a digital-output absolute pressure sensor, 409, and circuitry, described below, to receive the signals from the temperature sensor and the strain gauge and convert them into digital form.

A feed-through 407, in the form of a pin header cast in epoxy in the wall of the cover, passes electrical signals from the inside of the pressurized area to the outside. The feed-through connects to the circuit board by way of four wires and a pluggable connector, 408. The metal enclosure provides both pressure containment and electrostatic shielding. The circuit board is coated and all exposed electrical connections on it are coated to prevent condensation from compromising the electrical signals. The pluggable connector is exposed to condensation, but it carries digital signals only, and these are much less prone to compromise by condensation than the analog signals from the temperature and strain sensors.

FIG. 5 is a block diagram showing the three sensor inputs and the analog signal processing in the meter. Strain gauge 209, powered by a 4.096 Volt regulated supply, creates a differential voltage signal proportional to the deflection of vane 200. That signal is amplified by instrumentation amplifier 501, which may be Analog Devices part AD8293-G160, and provided as a first input to analog to digital convertor 502. RTD 308, with a nominal resistance of 100 Ohms, is connected to ground and, through a 10 K Ohm resistor, to the 4.096 Volt supply. Its output is provided as a second input to ADC 502.

ADC 502 is a 16-bit device with selectable gains ranging from 1:1 to 8:1, such as Microchip part MCP3426. The selectable gain permits the amplification of the strain-gauge signal to be increased when the flow is low, improving the dynamic range of the device. The gain and resolution of the ADC permit the simple temperature circuit to provide adequate resolution without additional amplification.

Pressure sensor 409 is a self-contained absolute-pressure sensor with digital output. It and ADC 502 communicate with microprocessor 503 through a shared 12C bus.

### Calculation of Flow

The force exerted by flowing fluid on an object can be estimated as:

F_{d}=c_{d}*A*ρ*V²/2 (1)

### Where:

c_{d} is the drag coefficient

A is the area of the object presented to the flow

ρ is the density of the fluid, and

V is the linear velocity of the fluid approaching the object.

The vane is allowed to bend somewhat relative to the flow, changing its orientation relative to the flow and bringing it closer to the distal portion of the probe body and farther from the protective cover, and these changes may significantly alter that drag force. This results in a small variation in c_{d} that can be corrected for during calibration. The force of interest is pressure distributed over the exposed portion of the vane, and it creates a moment about the flexible portion of the vane. The moment is the integral over the exposed area of the product of pressure and distance from the pivot, which is the flexible portion of the vane. Since the pressure on the vane is substantially uniform, the moment may be approximated as force F_{d} acting at the midpoint of the exposed portion of the vane. Accounting for these effects we have:

M_{d}=F_{d}*L (2)

### Where:

F_{d} is the force presumed to act at the center of the vane

M_{d} is the moment caused by the drag force,

L is the distance from the pivot to the center of the exposed portion of the vane

Distance L will vary somewhat as the vane flexes; this will be accounted for in calibration.

The output of the force measurement process is directly proportional to the moment applied to the flexible portion of the vane, thus:

F=M_{d}*G (3)

### Where:

F is the force signal, in digital form, resulting from the action of flowing fluid pressing against the vane, and

G is the gain of the measurement process.

For simplicity, we assume for now that the velocity is uniform over the area of the pipe.

We have:

Q=ρ*V*Aₚ (4)

### Where:

Q is the mass flow of fluid in the pipe, and

Aₚ is the area of the pipe.

Combining (1) through (4), we have:

$$Q = Ap * \sqrt{\frac{2 * F}{cd * A * G * L}} * \sqrt{ρ} = {Q}^{′} ( F ) * \sqrt{ρ} \qquad ( 5 )$$

Flow is thus expressed as the product of two expressions, Q′(F) and \sqrt{ρ}. The former is made up of quantities that are either constant between calibration conditions and application conditions or vary only with F, except that there will be some variation in Q′(F) if flow varies widely from a fully-developed profile. The latter, the square root of density, can easily be calculated knowing the specific gas constant of the gas being measured, the temperature and the pressure, given that under intended application conditions, the fluid closely approximates an ideal gas.

During calibration, a lookup table or mathematical expression representing Q′(F) is developed by dividing flow by the square root of density at each calibration point and relating the result to the observed value of the force output, F. An exponential expression may be found to fit the data reasonably well. In the event of reverse flow, the force signal F will be negative. Flow will be calculated by applying the absolute value of F to the lookup table, multiplying by the square root of density, and then applying the sign of F to the result.

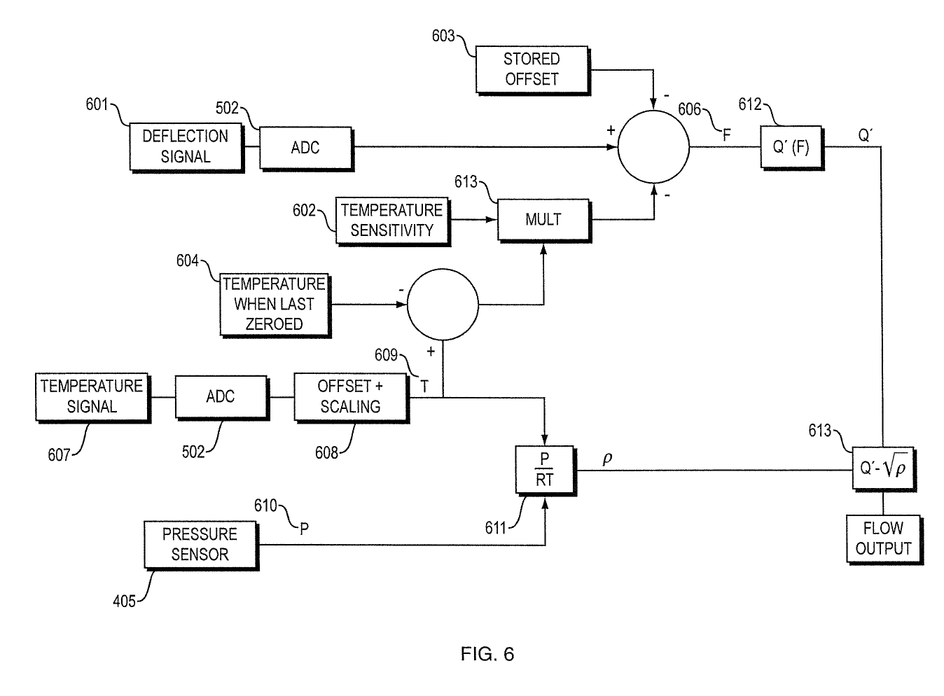

FIG. 6 is a block diagram showing the processing of the three sensor input signals to produce the calculated flow. This processing involves three steps. First is calculating the density of the fluid based on the absolute pressure and absolute temperature inputs. Next is correcting the raw output of the force sensor for any zero offset, including any temperature-related zero offset. The final step is determining mass flow by interpolation in lookup table 612 generated during calibration of the meter and multiplying the result by the square root of the density of the fluid.

During calibration, the temperature sensitivity 602 of the zero offset is determined by exposing the sensing vane to differing temperatures and noting the shift in the output with no applied load. The temperature sensitivity is calculated by dividing the shift in output by the change in applied temperature. The meter is zeroed when in place and at a time of no flow. When this is done both the force offset 603 and the corresponding temperature 604 are stored in memory.

In the first step of the flow measurement, offset and scaling 608 are applied to the temperature signal 607 processed by ADC 502 producing a value, T, 609, proportional to absolute temperature. Absolute pressure value P 610 is calculated based on input from pressure sensor 405 and calculations recommended by its manufacturer. The microcontroller then calculates density:

$$\frac{P}{R * T} 613 \qquad ( 9 )$$

where R is the specific gas constant for the gas being measured.

In the second step, the analog deflection signal 601 is amplified and converted to digital form by ADC 502. The temperature at which the meter was last zeroed 604 is subtracted from the current temperature 609 and the result is multiplied 613 by the temperature sensitivity of the offset 602. The result and the stored offset are subtracted from the ADC output 502 to provide a force signal (F) 606 for further calculations.

In the final step, the microprocessor determines the mass flow in the pipe by interpolating in lookup table 612 generated during the meter's calibration in a similar pipe, and multiplying the result by the square root of density. The lookup table accounts for variations in the flow profile across the pipe and small variations in the drag coefficient with changes in Reynolds number. (It will be noted that the Reynolds number associated with the flow profile in the pipe and the Reynolds number associated with flow around the probe are different. However, both vary in proportion to mass velocity, and thus both can be accounted for together.)

In applications in which the flow may be negative, the lookup in Table 612 must be performed using the absolute value of F, with the sign of F applied to the result.

The calibration is performed by applying a series of flow rates to the meter, noting its values of pressure, temperature and force output at each flow rate, and assigning to each the measured flow rate in the pipe. The recorded data are used to calculate Q′(F), the mass flow divided by the square root of density, at each calibration point and create lookup table 612. The table is then recorded in the meter, which uses it to determine mass flow rate by interpolation.

If the meter were to be used only with fluid at one density and viscosity, the correction for density could be ignored. The deflection would be a function of flow rate only, and the calibration would provide the required correction. The pressure and temperature sensors would not be required,

### Alternative Embodiment for Saturated Steam

In the case of dry saturated steam, the density can be inferred from the temperature only; the pressure sensor is not required.

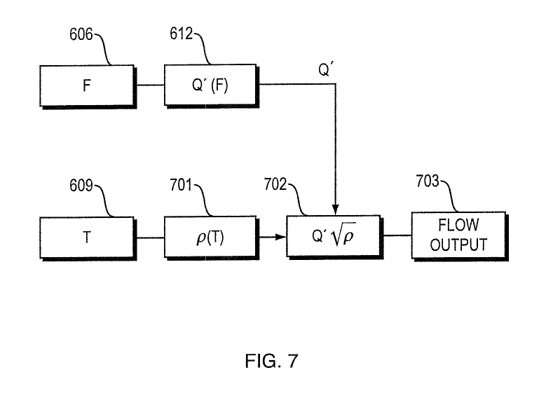

FIG. 7 is a diagram of how the flow calculation is performed for dry saturated steam. The density is determined from a lookup table of density vs. temperature for saturated steam, 701, on the basis of the temperature signal, 609. Then, as in FIG. 6, it uses the force signal that has been corrected for temperature and pressure, 606, in lookup table 612, to determine Q′ (F), and finally it multiplies this 702 by the density to determine the flow output 703.

Features to Protect Vane from Damage by Impact

The sensitivity of the meter depends on its ability to detect very small forces applied to the vane by moving fluid; these forces are detected by measuring strain at the surface of the flexible portion of the vane. Vastly greater forces will be applied to the vane by the impact of water droplets and solid particles. These impacts may occur at any point on the portion of the vane that is exposed to the oncoming fluid. The vane and its surroundings must be designed to prevent such impact forces from creating damaging strains in the flexible portion of the vane.

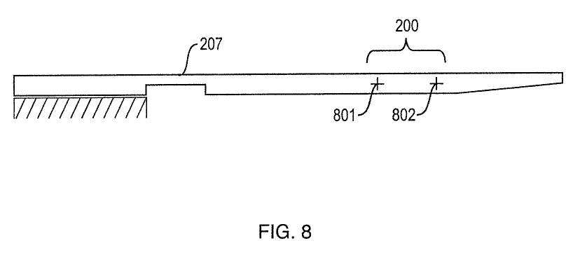

FIG. 8 is a side view of vane 200, showing its flexible portion 207, the center of mass of its movable portion 801, and the center of gyration 802 of its movable portion relative to its flexible portion. Flow is taken to be from above. If a particle strikes the vane at the indicated center of mass, 801, the movable portion of the vane will tend to move in direct translation, this will cause some stress at the flexible portion of the vane as the rigid portion must be accelerated into angular motion. If impact occurs at the indicated center of gyration, 802, the movable portion will rotate about the flexible portion, causing no stress other than what the vane is designed for, and the vane will soon come up against its stop. If impact occurs near the end of the vane, there will be a clockwise rotation causing the vane to tend to move upward at the flexible portion, but this will be largely offset by the downward translation of the part. If, however, impact occurs close to the flexible portion of the beam, most of the energy transferred to the beam will be absorbed as strain energy in that delicate portion, possibly causing damage. The extent of protective cover 301 (FIG. 5) is determined as a tradeoff between sensitivity and degree of protection, given that protection in the region of the center of gyration 802 is of relatively little benefit.

A number of implementations have been described. Nevertheless, it will be understood that additional modifications may be made without departing from the scope of the inventive concepts described herein, and, accordingly, other embodiments are within the scope of the following claims.

What is claimed is:

1. A flowmeter of the target type, comprising:
a probe that is arranged to be installed into a pipe through a small hole, where the pipe is arranged to carry a flow, the probe comprising a flow-sensing element that has a resting angular orientation relative to the flow;
wherein the probe is constructed and arranged to allow the flow-sensing element to change its angular orientation relative to the flow as the flow changes.

2. The flowmeter of claim 1, wherein the flowmeter undergoes a calibration process, and wherein an effect of the change in orientation is corrected for in the calibration process.

3. The flowmeter of claim 1 in which the flowmeter is a mass flowmeter.

4. The flowmeter of claim 1 wherein the probe further comprises a protective support for the flow-sensing element configured to prevent the flow-sensing element from bending excessively due to applied flow, and further reducing the likelihood of damage to the flow-sensing element as the probe is inserted into a pipe.

5. A flowmeter of the target type configured to clamp to a pipe and seal to the pipe, wherein the flowmeter comprises a flow-sensing probe projecting into the pipe.

6. A flowmeter of the target type, comprising:
a probe that is arranged to be installed into a pipe through a small hole, where the pipe is arranged to carry a flow, the probe comprising a flow-sensing element and a support for the flow-sensing element, wherein the flow-sensing element has substantially the same width as the support, thereby maximizing the projected area in the flow stream with a given size of hole for insertion of the probe into the pipe.

7. The flowmeter of claim 6, wherein the flow-sensing element has a resting angular orientation relative to the flow.

8. The flowmeter of claim 7, wherein the probe is constructed and arranged to allow the flow-sensing element to change its angular orientation relative to the flow as the flow changes.

9. The flowmeter of claim 8, wherein the flowmeter undergoes a calibration process, and wherein an effect of the change in orientation is corrected for in the calibration process.

10. The flowmeter of claim 8, wherein the probe further comprises a protective support for the flow-sensing element configured to prevent the flow-sensing element from bending excessively due to applied flow, and further reducing the likelihood of damage to the flow-sensing element as the probe is inserted into a pipe.

11. The flowmeter of claim 6, in which the flowmeter is a mass flowmeter.
